(19) United States
(12) Patent Application Publication
(10) Pub. No.: US 2011/0320185 A1
(43) Pub. Date: Dec. 29, 2011

(54) SYSTEMS AND METHODS FOR MACHINE TRANSLATION

(76) Inventor: Oded BROSHI, Bar Giora (IL)

(21) Appl. No.: 13/167,222

(22) Filed: Jun. 23, 2011

Related U.S. Application Data
(60) Provisional application No. 61/358,081, filed on Jun. 24, 2010.

(51) Int. Cl. G06F 17/28

(52) U.S. Cl. 704/4

(57) ABSTRACT

Systems and methods for machine translation are presented. Embodiments of the systems and methods comprise receiving a phrase table, the phrase table comprising a bi-phrase having a source phrase in a source language and a parallel translated target phrase in a target language; replacing a word in the source and/or target phrase with an inflected version of the word, replacing a word in the source and/or target phrase with a declined version of the word, replacing the word in the source and/or target phrase with a word having a different conjugation, replacing the word in the source and/or target phrase with a word having an equivalent semantic function, and/or replacing the word in the source and/or target phrase with a different adjective or adverb; creating a new source and/or target phrase which is identical to the source and/or target phrase except for the replaced word; and storing the new source and/or target phrase in an augmented phrase table.

### CROSS-REFERENCE TO RELATED APPLICATIONS

This application is based on and derives the benefit of the filing date of U.S. Provisional Patent Application No. 61/358,081, filed Jun. 24, 2010. The entire content of this application is herein incorporated by reference in its entirety.

### BRIEF DESCRIPTION OF THE DRAWINGS

FIG. 1 depicts a system for machine translation according to an embodiment of the invention.

FIG. 2 is a flow chart for a method of creating an augmented phrase table according to an embodiment of the invention.

FIG. 3 is an example of a method for mapping corresponding words according to an embodiment of the invention.

FIG. 4 is an example of a method for inflecting words according to an embodiment of the invention.

FIG. 5 is an example of a portion of a phrase table according to an embodiment of the invention.

FIG. 6 is an example of a method for generating a portion of a phrase table according to an embodiment of the invention.

FIG. 7 is an example of a method for generating a portion of a phrase table according to an embodiment of the invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the invention may comprise one or more computers. A computer may be any programmable machine capable of performing arithmetic and/or logical operations. In some embodiments, computers may comprise processors, memories, data storage devices, and/or other commonly known or novel components. These components may be connected physically or through network or wireless links. Computers may also comprise software which may direct the operations of the aforementioned components. Computers may be referred to with terms that are commonly used by those of ordinary skill in the relevant arts, such as servers, PCs, mobile devices, and other terms. It will be understood by those of ordinary skill that those terms used herein are interchangeable, and any computer capable of performing the described functions may be used. For example, though the term “server” may appear in the following specification, the disclosed embodiments are not limited to servers. The term server may refer to a single server or to a functionally associated cluster of servers. Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computer selectively activated or reconfigured by a computer program stored in the computer. Such a computer program may be stored in a computer readable storage medium, including but not limited to any type of disk including floppy disks, optical disks, CD-ROMs, magnetic-optical disks, read-only memories (ROMs), random access memories (RAMS) electrically programmable read-only memories (EPROMs), electrically erasable and programmable read only memories (EEPROMs), magnetic or optical cards, or any other type of media suitable for storing electronic instructions and capable of being coupled to a computer system bus. The processes and displays presented herein may not be inherently related to any particular computer or other apparatus. Various general purpose systems may be used with programs in accordance with the teachings herein, or it may prove convenient to construct a more specialized apparatus to perform the desired method. It should also be understood that the techniques of the present invention may be implemented using a variety of technologies. For example, the methods described herein may be implemented in software executing on a computer system, or implemented in hardware utilizing either a combination of microprocessors or other specially designed application specific integrated circuits, programmable logic devices, or various combinations thereof. In particular, the methods described herein may be implemented by a series of computer-executable instructions residing on a suitable computer-readable medium. Suitable computer-readable media may include volatile (e.g., RAM) and/or non-volatile (e.g., ROM, disk) memory, carrier waves and transmission media (e.g., copper wire, coaxial cable, fiber optic media). Exemplary carrier waves may take the form of electrical, electromagnetic or optical signals conveying digital data streams along a local network, a publicly accessible network such as the Internet or some other communication link.

Suitable structures for a variety of these systems may appear from the description below. In addition, embodiments of the present invention are not described with reference to any particular programming language. It will be appreciated that a variety of programming languages may be used to implement the teachings of the inventions as described herein.

Terms in this application relating to distributed data networking, such as send or receive, may be interpreted in reference to Internet protocol suite, which is a set of communications protocols that implement the protocol stack on which the Internet and most commercial networks run. It has also been referred to as the TCP/IP protocol suite, which is named after two of its protocols: the Transmission Control Protocol (TCP) and the Internet Protocol (IP).

The Internet Protocol suite—like many protocol suites—can be viewed as a set of layers. Each layer solves a set of problems involving the transmission of data, and provides a well-defined service to the upper layer protocols based on using services from some lower layers. Upper layers are logically closer to the user and deal with more abstract data, relying on lower layer protocols to translate data into forms that can eventually be physically transmitted. The TCP/IP reference model consists of four layers.

The IP suite uses encapsulation to provide abstraction of protocols and services. Generally a protocol at a higher level uses a protocol at a lower level to help accomplish its aims. The Internet protocol stack has never been altered, by the IETF, from the four layers defined in RFC 1122. The IETF makes no effort to follow the seven-layer OSI model and does not refer to it in standards-track protocol specifications and other architectural documents.

| | |
|---|---|
| 4. Application | DNS, TFTP, TLS/SSL, FTP, Gopher, HTTP, |
| | IMAP, IRC, NNTP, POP3, SIP, SMTP, SNMP, SSH, |
| | TELNET, ECHO, RTP, PNRP, rlogin, ENRP |
| | Routing protocols like BGP, which for a variety of |
| | reasons run over TCP, may also be considered part |
| | of the application or network layer. |
| 3. Transport | TCP, UDP, DCCP, SCTP, IL, RUDP |
| 2. Internet | Routing protocols like OSPF, which run over IP, are |
| | also to be considered part of the network layer, as they |
| | provide path selection. ICMP and IGMP run over IP |
| | and are considered part of the network layer, as they |
| | provide control information. |
| | IP (IPv4, IPv6) |
| | ARP and RARP operate underneath IP but above the |
| | link layer so they belong somewhere in between. |
| 1. Network access | Ethernet, Wi-Fi, token ring, PPP, SLIP, FDDI, ATM, |
| | Frame Relay, SMDS |

It should be understood that any topology, technology and/or standard for computer networking (e.g. mesh networks, infiniband connections, RDMA, etc.), known today or to be devised in the future, may be applicable to the present invention.

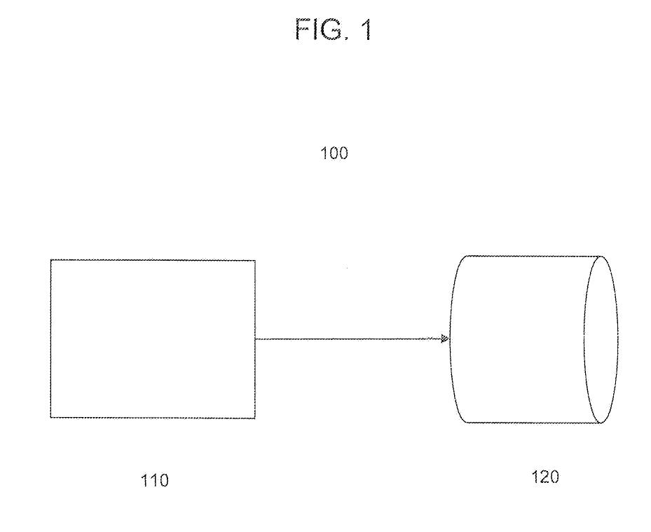

Embodiments of the present invention may provide systems and methods for augmenting phrase tables used in machine translation (MT). FIG. 1 depicts a system for machine translation according to an embodiment of the invention. At least one translating computer 100 may comprise at least one processor 110 and at least one database 120 in communication with the at least one processor 110. The at least one processor 110 may be constructed and arranged to perform MT according to approaches described below and/or other approaches. The at least one database 120 may be constructed and arranged to include data such as phrase tables and other data that may be used by the at least one processor 110 in MT operations.

There may be many approaches to machine translation, and while embodiments are described in the context of certain approaches, it will be understood that they may be applied to additional known or unknown approaches. Some approaches, such as example-based and statistical MT, may be based on large bi-lingual corpora. A large bilingual corpus is, for example, two large texts in source and target languages which are translations of each other and can be aligned at sentence level. Alignment at sentence level means that corresponding lines of the two texts contain sentences that are translations of each other. The bilingual material may be separated into a training set, a tuning set, and/or an evaluation set. The training set may be a set from which bi-phrases may be extracted and from which the weights of the bi-phrases may be learned. Bi-phrases are pairs of phrases wherein each phrase is a translation of its pair in the bi-phrase. A separate monolingual corpus in the target language may be used to train the language model. The tuning set may be used to adjust values of parameters of a decoder. The evaluation set may be used to assess translation quality.

Phrase tables may be used to help resolve ambiguity in words in a source text which is being machine translated. MT applications that utilize phrase tables may improve the contextual accuracy of their translations by statistically correlating groups of words (i.e. phrases) within the source text with phrases contained in phrase tables. In this fashion, ambiguous words (words having more than one meaning) may be translated by taking into consideration the context (i.e. surroundings) in which they appear. When attempting to translate an ambiguous word, a MT application may search for phrases within the phrase tables which may contain the ambiguous word in combination with other words that may appear in close proximity to the ambiguous word in the source text. By statistically analyzing the identified phrases within the phrase tables, a possible translation of the word may be determined based on similarities in the context of the table phrase and the phrase being translated.

Phrase tables may be derived from large bi-lingual corpora (sets of pairs of texts, wherein each text is a translation of its pair). For example, the bi-lingual texts used for the creation of phrase tables may be texts that have already been translated by humans, e.g. the Bible. These texts may be transformed into digital form if needed, for example by scanning them and then performing an optical character recognition (“OCR”) process upon the scanned text. The texts may be aligned so that corresponding sentences (i.e. sentences having the same meaning in different languages) are matched to each other. Once the texts are aligned, corresponding phrases (i.e. phrases having the same meaning in different languages) within the text may be identified and separated into lists of such pairs of phrases. These lists may then be compiled into phrase tables. Thus, the end result may be a list of phrases that appear in the original text with their translations.

Statistical machine translation (SMT) may use a probabilistic representation of natural languages and the translation process. For possible pairs of source language sentence x and target language sentence y, a value Pr(y|x) may be defined. This value may represent a probability that, given the sentence x, a translator would choose y as its translation. The best translation given a sentence x is then defined as the sentence y that maximizes Pr(y|x). Using Bayes' theorem this can be rewritten as

$$Pr ( ylx ) = \frac{Pr ( y ) Pr ( xly )}{Pr ( x )}$$

For a given source sentence the denominator is constant. Therefore the sentence

$$y = {argmax}_{y} Pr ( \underline{xly} ) Pr ( y )$$

may be the best translation for the source sentence x.

Pr(y) may model the probability that the sentence y is a valid sentence in the target language, while Pr(y|x) may model the probability that y is a good translation for x. The former model may be called the language model, the latter may be called the translation model. Some language models may be based on counts of occurrences of sequences of n successive words, the n-grams, in large monolingual texts. Some translation models, on the other hand, may be based on knowledge extracted from very large bi-lingual texts.

The knowledge extracted from the bilingual corpora in SMT systems to model the translation probabilities may take different forms. For example it may comprise syntactic rules, which may represented as operations on parse trees, in the case of syntax-based SMT. It may comprise pairs of corresponding sequences of words in the source and target languages (“aligned phrases”) in the case of phrase-based SMT. The set of corresponding sequences of words in the source and target languages may be called a phrase table. The extracted sequences of words in the source and target languages may be of different size and/or may appear in different orders in the source and target languages.

Phrase-based SMT systems may model the translation process using pairs of corresponding sequences of words extracted from parallel corpora (bi-phrases). These bi-phrases may be stored in phrase tables that may contain several million such entries. Pairs of corresponding phrases, together with their word to word links (the bi-phrases), may be extracted from sentence aligned bilingual corpora using statistical and heuristic models. Word alignments may be computed and stored in a phrase table.

The example-based machine translation (EBMT) approach to machine translation may use a bilingual corpus with parallel texts as its main knowledge base, at run-time. EMBT may essentially be a translation by analogy and may be viewed as an implementation of case-based reasoning approach of machine learning. Translation by analogy may be a process wherein translators translate firstly by decomposing a sentence into certain phrases, then by translating these phrases, and finally by composing these fragments into a translated sentence. Phrasal translations may be translated by analogy to previous translations. The principle of translation by analogy may be encoded into EMBT through the example translations that may be used to train such a system. These example translations may be basically analogous to the phrase tables described above.

The phrase tables may be contained in one or more databases functionally associated with the MT application, directly and/or via a distributed data network, such as the Internet. In some cases, for example EBMT embodiments, correlations may be performed in real time. In other cases, for example SMT applications, correlations may be performed after first statistically analyzing phrase tables in advance and creating sets of rules derived from this analysis.

According to some embodiments of the present invention, MT utilizing phrase tables, such as SMT or EBMT, may be performed after first augmenting phrase tables with bi-phrases derived by inflecting each word in the existing bi-phrases within the existing phrase tables. According to further embodiments of the present invention, while performing MT utilizing phrase tables, inflections of words within the source text (i.e. the text being translated) may also be considered when searching for statistical correlations between phrases within the source text and phrases in the phrase tables.

According to some embodiments of the present invention, phrase tables which may be functionally associated with a MT application may be augmented with bi-phrases derived by inflecting, conjugating, and/or declining words within the existing bi-phrases. A phrase table augmenting application may derive additional bi-phrases by inflecting, conjugating, and/or declining some or all words within a bi-phrase contained in the phrase table in some or all possible inflections and creating a new bi-phrase for each inflection. The new bi-phrases may be added to the set of bi-phrases comprising the phrase table to create an augmented phrase table containing all the original bi-phrases with the addition of the inflected bi-phrases. An MT application using the augmented phrase table may be able to correlate a phrase in a source text with the corresponding phrases in the phrase table even when one or more words in the phrase are inflected differently than they were in the original text used to create the phrase table.

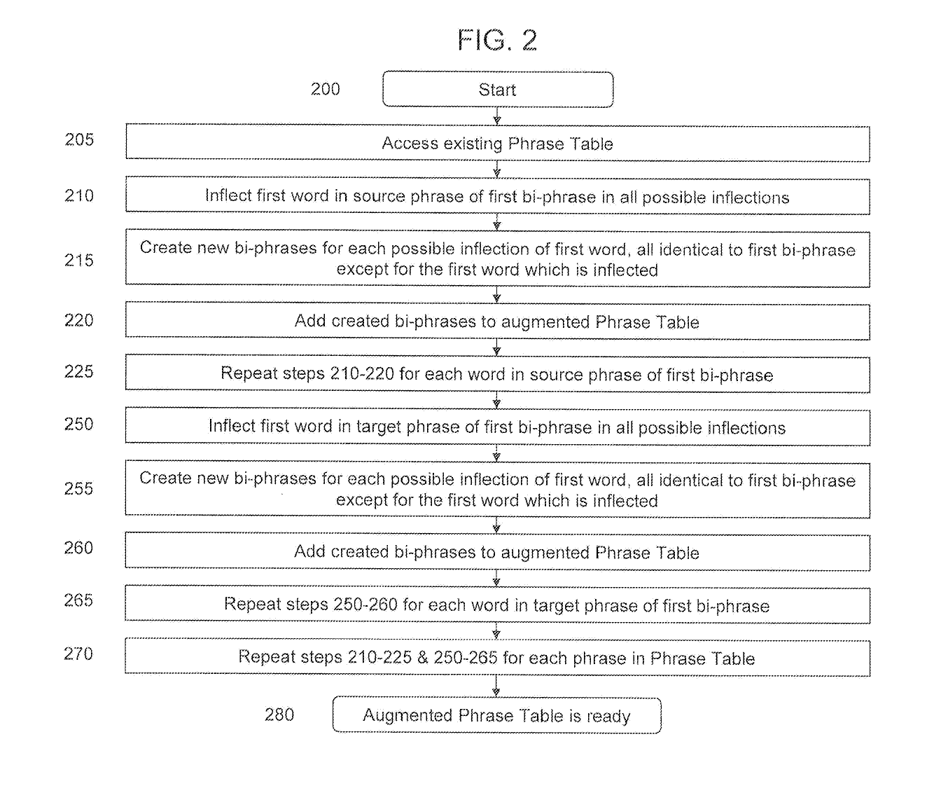

FIG. 2 is a flow chart for a method of creating an augmented phrase table according to an embodiment of the invention. A computer application running on a processor 110 may access an existing phrase table 205 which may be stored in a database 120 or other memory. The application may inflect a first word in the source phrase of the first bi-phrase 210. The application may inflect, conjugate, and/or decline the word. The following example is discussed in the context of inflection. The application may inflect the word using all possible inflections or a subset thereof. The application may create new bi-phrases for each inflection it has performed on the first word 215. These bi-phrases may be the same phrase as the original bi-phrase except for the changed inflected word. These new bi-phrases may be incorporated into an augmented phrase table 220. Steps 210-220 may be repeated for additional words in the source phrase 225. For example, every word in the source phrase may be inflected and incorporated into bi-phrases which are identical to the original except for the inflected word, and the new phrases may be added to the augmented phrase table.

Similarly, the application may inflect a first word in the target phrase of the first bi-phrase 250. The application may inflect the word using all possible inflections or a subset thereof. The application may create new bi-phrases for each inflection it has performed on the first word 255. These bi-phrases may be the same phrase as the original bi-phrase except for the changed inflected word. These new bi-phrases may be incorporated into the augmented phrase table 260. Steps 250-260 may be repeated for additional words in the target phrase 265. For example, every word in the target phrase may be inflected and incorporated into bi-phrases which are identical to the original except for the inflected word, and the new phrases may be added to the augmented phrase table. In some embodiments, the application may perform augmentation using either the source or the target phrase only, leaving the other phrase non-augmented.

The phrases making up a pair of bi-phrases may be referred to as a source phrase and a target phrase. In some cases, the source phrase may be a phrase in a language that is to be translated, and the target phrase may be a phrase in a second language into which the translation is to be made. However, those of ordinary skill in the art will appreciate that the same bi-phrases may be used when the source language and the target language are reversed. Therefore, the use of “source phrase” or “source language” and/or “target phrase” or “target language” in any example, embodiment, or claim is not intended to limit any pair of bi-phrases to a single direction of translation. It will be understood that the source language and target language may be any languages, and also that the source language and target language may be interchangeable. For example, a source language may be any first language and a target language may be any second language in a given act of translation. In a different act of translation, the first language may be the target language and the second language may be the source language. The same phrase tables may be used for either case, or separate phrase tables for the two cases could be generated and/or augmented.

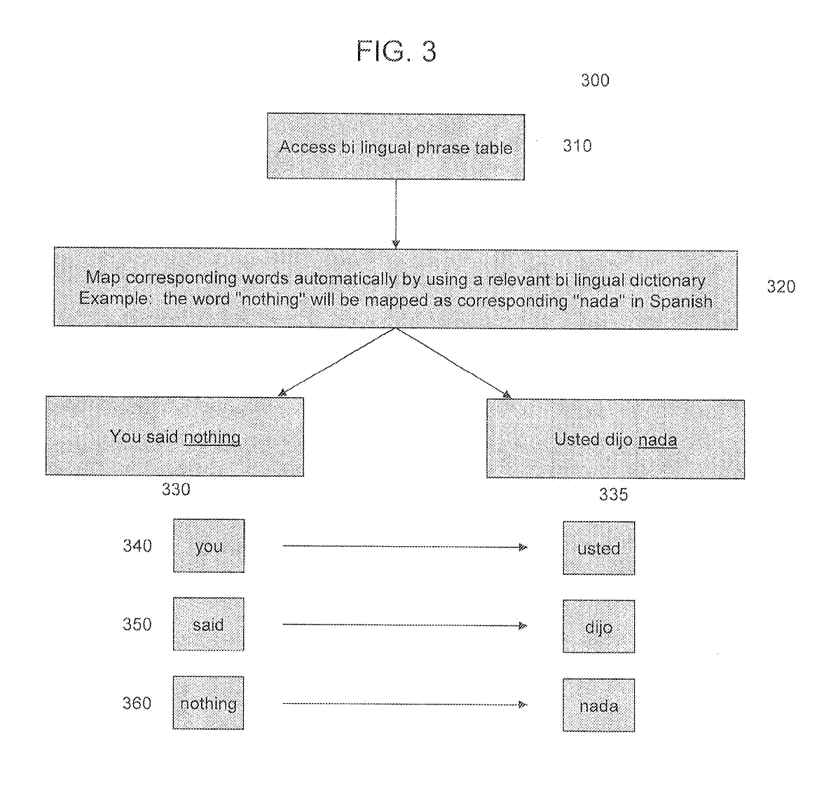

In some embodiments, the phrase table augmenting application may also map corresponding words in bi-phrases. FIG. 3 is an example of a method for mapping corresponding words according to an embodiment of the invention. The application may access a bilingual phrase table 310 with bi-phrases. In a bi-phrase, corresponding words may be mapped to one another using a multi-lingual dictionary containing at least the two languages that make up the source and target portions of the bi-phrase 320. In the example of FIG. 3, an English phrase “You said nothing” 330 and a Spanish phrase “listed dijo nada” 335 may be mapped to one another. The application may translate “you” to “usted” 350, “said” to “dijo” 350, and “nothing” to “nada” 360; and/or vice versa. Mapping may be performed before and/or after augmentation.

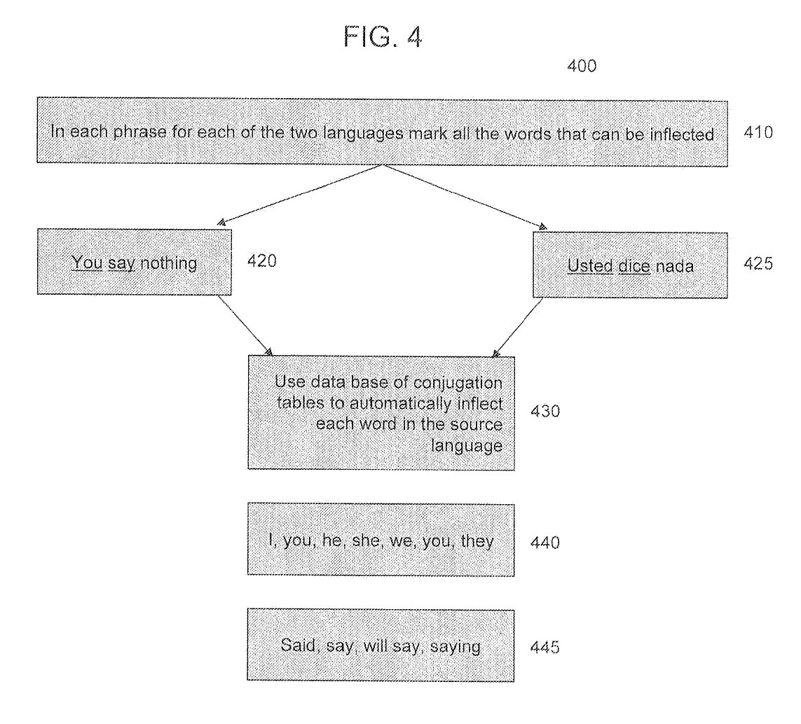

A phrase table augmenting application may include inflection logic which may comprise a rule set defining how to inflect words, in different inflections, in one or more languages and may further include inflection translation logic which may comprise one or more rule sets determining correct modifications to translations of words based on their inflection in the source language. FIG. 4 is an example of a method for inflecting words according to an embodiment of the invention. The application may mark some or all of the words that may be inflected in each phrase of a bi-phrase 410. In the example of FIG. 4, “you” and “say” may be marked as capable of being inflected in the source phrase 420, and “usted” and “dices” may be marked in the target phrase 425. The application may access conjugation tables 430 which may be stored in a database 120 or other memory. In this example, the conjugation tables 430 may include “I, you, be, she, we, you, they” as possible inflections for the first word in the source phrase 440, and “said, say, will say, saying” as possible inflections for the second word in the source phrase 445. The application may use these table entries to carry out an augmentation such as the one described with respect to FIG. 2 above.

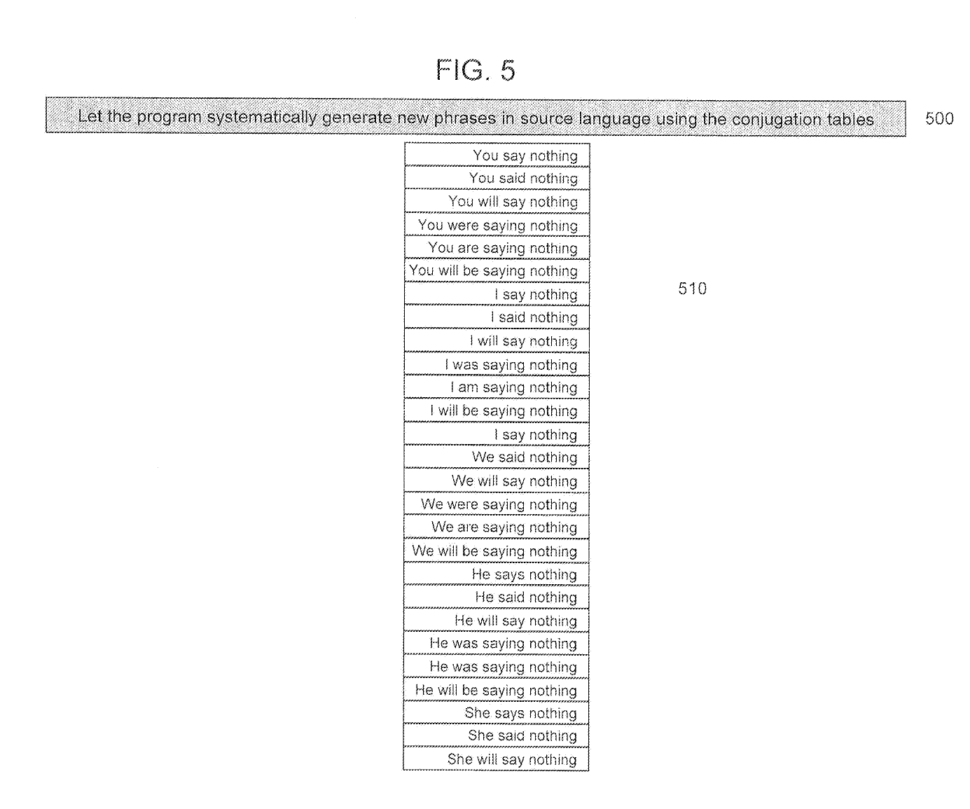

FIG. 5 is an example of a portion of a phrase table according to an embodiment of the invention. Continuing the example of FIG. 4, the phrase table portion 510 may be an augmented set of source phrases based on the source phrase “You say nothing” wherein “you” and “say” have been inflected 500.

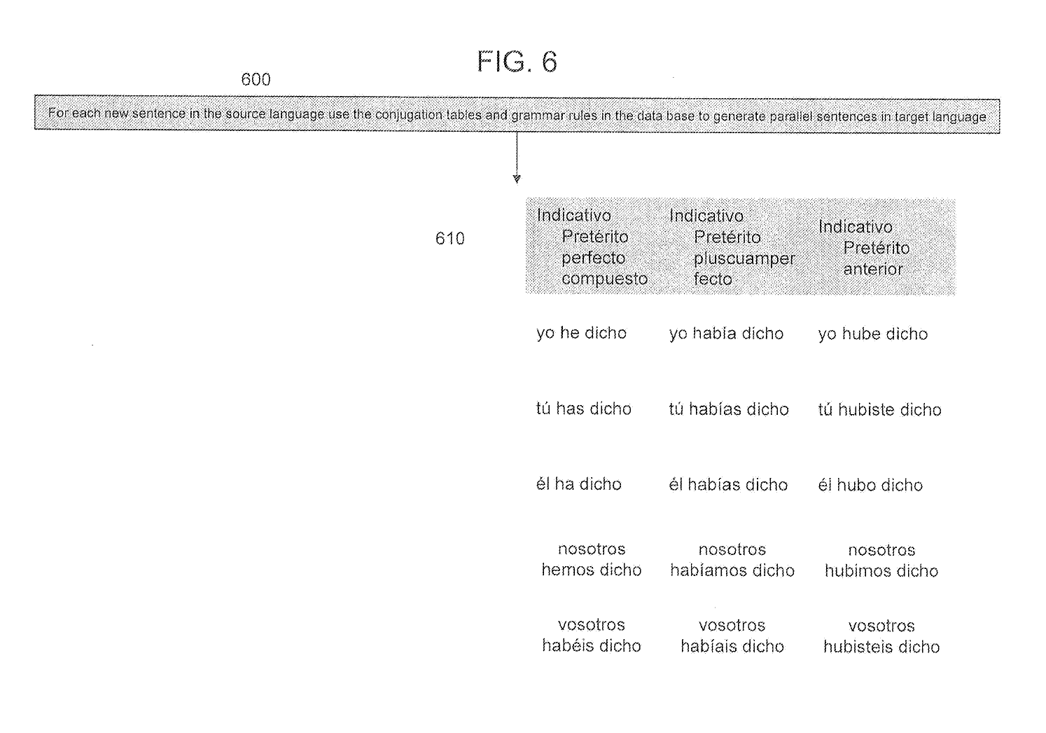

FIG. 6 is an example of a method for generating a portion of a phrase table according to an embodiment of the invention. In some embodiments, target phrases for an augmented phrase table may be generated by using conjugation tables and/or grammar rules stored in a database 120 or other medium to generate parallel target phrases 600. For example, the English phrase “You say nothing” may be translated into Spanish. The resulting phrase may be, for example, “listed no dice nada” or another phrase having different word inflections. In any case, the words in the target language phrase which are capable of inflection may be inflected 610 according to the conjugation tables and/or grammar rules available to the application.

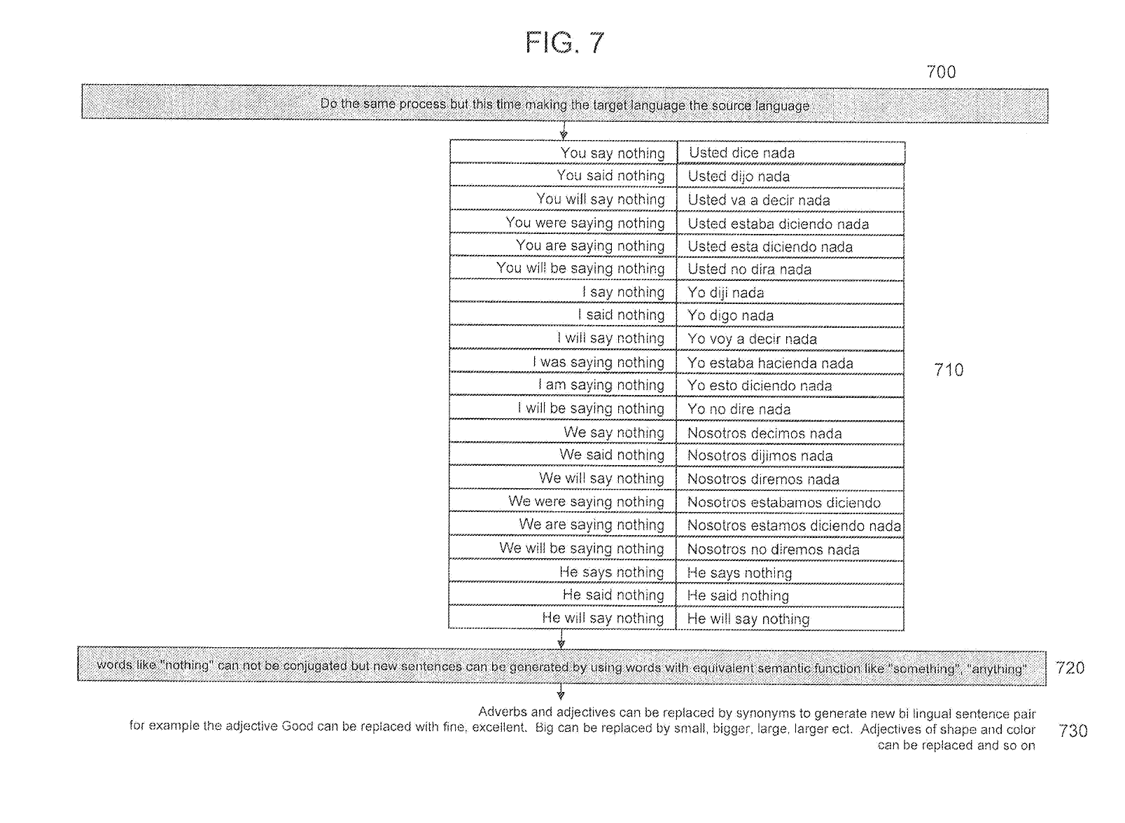

FIG. 7 is an example of a method for generating a portion of a phrase table according to an embodiment of the invention. Continuing the “You say nothing” example, the process described with respect to FIGS. 4-6 may be repeated with the target phrase becoming the source phrase and vice versa 700. This may enable the application to fill in any missing entries in the augmented phrase table 710. In some embodiments, the application may augment the phrase table by replacing words that cannot be inflected according to grammar and/or conjugation rules 720. For example, the word “nothing” may be replaced with words having similar semantic function such as “something” or “anything” to form additional bi-phrases. Also, words such as adjectives and/or adverbs may be replaced with synonyms 730. For example, “good” may be replaced with “excellent” or “big” may be replaced with “large.” to some cases, adjectives and/or adverbs having different meanings but similar semantic functions may be exchanged, for example “big” may be replaced with “small.” Any such replacements may be used to generate additional bi-phrases in a manner similar to that described above.

The phrase table augmenting application may be functionally associated with a specific MT application, augmenting phrase tables associated with that application or may operate independently of a MT application, augmenting phrase tables for use with various MT applications. Furthermore, an augmented phrase table may serve more than one MT application, possibly via a distributed data network, such as the Internet.

According to further embodiments of the present invention, a MT application attempting a statistical correlation between a phrase in a source text and a phrase table may be adapted to inflect words contained in the source phrase and to further statistically correlate the resulting phrases (i.e. the phrases derived by inflecting words in the source phrase) with phrases contained in the phrase table.

An MT application attempting to resolve the correct translation of an ambiguous word contained in a source text may refer to one or more phrase tables or sets of rules derived by statistical analysis of one or more phrase tables. The MT application may search the phrase table(s), or the derived rule set, for phrases that contain the ambiguous word in a context that has commonalities with the surroundings/context in which the ambiguous word appears in the source text. Phrases may be determined to have commonalities with the surroundings/context in which the ambiguous word appears in the source text when they contain the ambiguous word in combination with one or more words that appear in close proximity to the ambiguous word in the source text. Once such phrases are identified, a statistical analysis of the translations of the ambiguous word according to the translations of these phrases, within the phrase table(s), may be used to resolve the correct translation of the ambiguous word in the specific instance. Phrases within the phrase table(s) identified as having many commonalities with the source text (i.e. containing many words that also appear in close proximity to the ambiguous word in the source text) may be given a larger weight in this statistical analysis than those containing fewer commonalities.

According to some embodiments of the present invention a MT application may also:

(A) Inflect an ambiguous word in one or more or all possible inflections and search the phrase table(s), or the derived rule set, for phrases that contain the inflected ambiguous word in a context that may have commonalities with the surroundings/context in which the ambiguous word appears in the source text (i.e. searching for phrases containing inflections of the ambiguous word in combination with those words that appear in close proximity to the ambiguous word in the source text);

(B) Inflect each of the words that appears in close proximity to the ambiguous word in the source text, in one or more or all possible inflections, and search the phrase table(s), or the derived rule set, for phrases containing the ambiguous word in combination with each inflection of those words that appear in close proximity to the ambiguous word in the source text (i.e. searching for phrases that contain the ambiguous word in a context that may have commonalities with the surroundings/context in which the ambiguous word appears in the source text but with a different inflection); and/or

(C) Search the phrase table(s), or the derived rule set, for phrases containing inflections of the ambiguous word in combination with inflections of the those words that appear in close proximity to the ambiguous word in the source text (i.e. search for phrases that contain the ambiguous word, in a different inflection, in a context that may have commonalities with the surroundings/context in which the ambiguous word appears in the source text but with a different inflection).

These additional phrases may also be considered by the MT application when performing the statistical analysis of related phrases in the phrase table to determine a translation of the ambiguous word, as described above.

A MT application may also include an inflection module adapted to inflect words in a target language (a language into which a word or text is being translated) to represent an intended meaning of the word in the source text (a text being translated) and to recognize inflections of words in a source text and the modification to the intended meaning of the word they may cause. An inflection module may include inflection logic comprising a rule set which may define how to inflect words in one or more languages, based on an intended meaning or aspect of an intended meaning (e.g. the intended tense) of the word. The module may also include inflection translation logic which may be adapted to recognize inflections of words in a source language and comprising one or more rule sets which may determine an aspect of an intended meaning of a word based on its inflection.

Using the rule sets, the inflection module may assist a MT application in translating a source text by: (1) determining modifications to translations of words based on their inflection in the source text; and (2) determining inflections of words in a target language based on an intended meaning of the word in the source text. The intended meaning of a word in a source text, for the purpose of inflection, may be determined based on: (1) the inflection of the word in the source text; (2) statistical correlation of the surrounding text in the source text with phrases in phrase tables (as described above); (3) correlation of the surrounding text in the source text with rules contained in the rule sets contained in the inflection module; and/or (4) any other translation technique known today or to be devised in the future.

It should be understood by one of skill in the art that some of the functions described as being performed by a specific component of the system may be performed by a different component of the system in other embodiments of this invention.

Embodiments of the present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. It should be recognized, however, that the present invention might be practiced without resorting to the details specifically set forth. In the description and claims of embodiments of the present invention, each of the words, “comprise” “include” and “have”, and forms thereof, are not necessarily limited to members in a list with which the words may be associated.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than those shown.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

It should also be noted that the terms “a”, “an”, “the”, “said”, etc. signify “at least one” or “the at least one” in the specification, claims and drawings.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method comprising:
receiving a phrase table with a processor, the phrase table comprising a bi-phrase having a source phrase in a source language and a parallel translated target phrase in a target language;
replacing a word in the source phrase with an inflected version of the word with the processor, replacing a word in the source phrase with a declined version of the word with the processor, replacing the word in the source phrase with a word having a different conjugation with the processor, replacing the word in the source phrase with a word having an equivalent semantic function with the processor, and/or replacing the word in the source phrase with a different adjective or adverb with the processor;
creating a new source phrase which is identical to the source phrase except for the replaced word with the processor; and
storing the new source phrase in an augmented phrase table in a database.

2. The method of claim further comprising:
replacing a word in the parallel translated target phrase with an inflected version of the word with the processor, replacing a word in the parallel translated target phrase with a declined version of the word with the processor, replacing the word in the source phrase with a word having a different conjugation with the processor, replacing the word in the parallel translated target phrase with a word having an equivalent semantic function with the processor, and/or replacing the word in the parallel translated target phrase with a different adjective or adverb with the processor;
creating a new parallel translated target phrase which is identical to the parallel translated target phrase except for the replaced word with the processor; and
storing the new parallel translated target phrase in the augmented phrase table in the database.

3. The method of claim 2, wherein the replaced word in the source phrase and the replaced word in the parallel translated target phrase have corresponding meanings.

4. The method of claim 1, further comprising:
marking every word that can be inflected, conjugated, declined, replaced with a word having an equivalent semantic function, and/or replaced with a different adjective or adverb in the source phrase and the parallel translated target phrase with the processor;
replacing every word that can be inflected, conjugated, declined, replaced with a word having an equivalent semantic function, and/or replaced with a different adjective or adverb in the source phrase and the parallel translated target phrase with an inflected version of the word with the processor;
creating a new source phrase corresponding to each of the words in the source phrase that can be inflected, conjugated, declined, replaced with a word having an equivalent semantic function, and/or replaced with a different adjective or adverb and a new parallel translated target phrase corresponding to each of the words in the parallel translated target phrase that can be inflected, conjugated, declined, replaced with a word having an equivalent semantic function, and/or replaced with a different adjective or adverb with the processor, wherein each of the new source phrases is identical to the source phrase except for the replaced word and each of the new parallel translated target phrases is identical to the parallel translated target phrase except for the replaced word; and
storing each of the new source phrases and each of the new parallel translated target phrases in an augmented phrase table in the database.

5. The method of claim 1, further comprising:
determining a meaning of every word in the source phrase with the processor;
determining a meaning of every word in the parallel translated target phrase with the processor;
determining pairs of word sets having the same meaning with the processor, wherein each pair contains one or more matching words from the source phrase and one or more matching words from the parallel translated target phrase;
creating a table including the pairs with the processor; and
storing the table in the database.

6. The method of claim 1, further comprising:
translating the source phrase into the target language to form a translated phrase with the processor; and
storing the translated phrase in the augmented phrase table in the database.

7. The method of claim 1, further comprising:
searching the augmented phrase table for a third phrase comprising the inflected, conjugated, declined, replaced with a word having an equivalent semantic function, and/or replaced with a different adjective or adverb version of the word and another word in the source phrase with the processor.

8. The method of claim 1, further comprising:
searching the augmented phrase table for a third phrase comprising the word and an inflected, conjugated, declined, replaced with a word having an equivalent semantic function, and/or replaced with a different adjective or adverb version of another word in the source phrase with the processor.

9. The method of claim 1, further comprising:
searching the augmented phrase table for a third phrase comprising the inflected, conjugated, declined, replaced with a word having an equivalent semantic function, and/or replaced with a different adjective or adverb version of the word and an inflected, conjugated, declined, replaced with a word having an equivalent semantic function, and/or replaced with a different adjective or adverb version of another word in the source phrase with the processor.

10. A system comprising:
a database; and
a processor constructed and arranged to:
communicate with the database;
receive a phrase table, the phrase table comprising a bi-phrase having a source phrase in a source language and a parallel translated target phrase in a target language;
replace a word in the source phrase with an inflected version of the word, replace a word in the source phrase with a declined version of the word, replace the word in the source phrase with a word having a different conjugation, replace the word in the source phrase with a word having an equivalent semantic function, and/or replace the word in the source phrase with a different adjective or adverb;
create a new source phrase which is identical to the source phrase except for the replaced word; and
store the new source phrase in an augmented phrase table in the database.

11. The system of claim 9, wherein the processor is further constructed and arranged to:
replace a word in the parallel translated target phrase with an inflected version of the word, replace a word in the parallel translated target phrase with a declined version of the word, replace the word in the parallel translated target phrase with a word having a different conjugation, replace the word in the parallel translated target phrase with a word having an equivalent semantic function, and/or replace the word in the parallel translated target phrase with a different adjective or adverb;
create a new parallel translated target phrase which is identical to the parallel translated target phrase except for the replaced word; and
storing the new parallel translated target phrase in the augmented phrase table in the database.

12. The system of claim 10, wherein the replaced word in the source phrase and the replaced word in the parallel translated target phrase have corresponding meanings.

13. The system of claim 9, wherein the processor is further constructed and arranged to:
mark every word that can be inflected, conjugated, declined, replaced with a word having an equivalent semantic function, and/or replaced with a different adjective or adverb in the source phrase and the parallel translated target phrase;
replace every word that can be inflected, conjugated, declined, replaced with a word having an equivalent semantic function, and/or replaced with a different adjective or adverb in the source phrase and the parallel translated target phrase with an inflected version of the word;
create a new source phrase corresponding to each of the words in the source phrase that can be inflected, conjugated, declined, replaced with a word having an equivalent semantic function, and/or replaced with a different adjective or adverb and a new parallel translated target phrase corresponding to each of the words in the parallel translated target phrase that can be inflected, conjugated, declined, replaced with a word having an equivalent semantic function, and/or replaced with a different adjective or adverb, wherein each of the new source phrases is identical to the source phrase except for the replaced word and each of the new parallel translated target phrases is identical to the parallel translated target phrase except for the replaced word; and
store each of the new source phrases and each of the new parallel translated target phrases in an augmented phrase table in the database.

14. The system of claim 9, wherein the processor is further constructed and arranged to:
determine a meaning of every word in the source phrase;
determine a meaning of every word in the parallel translated target phrase;
determine pairs of word sets having the same meaning, wherein each pair contains one or more matching words from the source phrase and one or more matching words from the parallel translated target phrase;
create a table including the pairs; and
store the table in the database.

15. The system of claim 9, wherein the processor is further constructed and arranged to:
translate the source phrase into the parallel translated target language to form a translated phrase; and
store the translated phrase in the augmented phrase table in the database.

16. The system of claim 9, wherein the processor is further constructed and arranged to:
search the augmented phrase table for a third phrase comprising the inflected, conjugated, declined, replaced with a word having an equivalent semantic function, and/or replaced with a different adjective or adverb version of the word and another word in the source phrase.

17. The system of claim 9, wherein the processor is further constructed and arranged to:
search the augmented phrase table for a third phrase comprising the word and an inflected, conjugated, declined, replaced with a word having an equivalent semantic function, and/or replaced with a different adjective or adverb version of another word in the source phrase.

18. The system of claim 9, wherein the processor is further constructed and arranged to:
search the augmented phrase table for a third phrase comprising the inflected, conjugated, declined, replaced with a word having an equivalent semantic function, and/or replaced with a different adjective or adverb version of the word and an inflected, conjugated, declined, replaced with a word having an equivalent semantic function, and/or replaced with a different adjective or adverb version of another word in the source phrase.
